(19) United States
(12) Patent Application Publication
(10) Pub. No.: US 2011/0053563 A1
(43) Pub. Date: Mar. 3, 2011

(54) PORTABLE HANDSFREE DEVICE WITH LOCAL VOICEMAIL SERVICE FOR USE WITH A MOBILE TERMINAL

(75) Inventor: Staffan BJORKLUND, Caribbean at Keppel Bay (SG)

(73) Assignee: SONY ERICSSON MOBILE COMMUNICATIONS AB, Lund (SE)

(21) Appl. No.: 12/551,793

(22) Filed: Sep. 1, 2009

(51) Int. Cl. H04M 11/10; G06F 17/20

(52) U.S. Cl. 455/412.2; 455/413; 704/8

(57) ABSTRACT

A portable handsfree device for use with a mobile terminal is disclosed. The portable handsfree device has an audio interface over which a user may conduct voice calls, a processing unit, and a memory unit. The processing unit is adapted for providing a local voicemail service by playing a greeting message to a caller of an incoming voice call to said mobile terminal and recording, in said memory unit, a voicemail message from said caller. The processing unit is adapted for making the greeting message configurable by the user.

### TECHNICAL FIELD

The present invention relates to the field of portable electronic equipment, and in particular to a portable handsfree device with local voicemail service for use with a mobile terminal.

### BACKGROUND

Portable electronic equipment of course exists in many different types. One very common example is a mobile terminal, such as a mobile telephone for a mobile telecommunications system like GSM, UMTS, D-AMPS, CDMA2000, FOMA or TD-SCDMA.

Nowadays, mobile terminals are frequently used for various different telecommunications services, such as voice calls, Internet browsing, video calls, data calls, facsimile transmissions, still image transmissions, video transmissions, electronic messaging, and e-commerce. Still, traditional voice calls of course remain as a central intended use for mobile terminals.

Accessories have been developed to facilitate the use of mobile terminals when conducting voice calls. A popular type of accessory is the portable handsfree device. Such a device provides the user with an audio interface (including an extra set of speaker(s) and microphone(s)) for the user to the mobile terminal for the purpose of conducting a voice call without having to hold the mobile terminal in the traditional position next to the head.

WO 2006/136266 discloses a handsfree device which is used with a mobile terminal and enables a user to monitor calls in a “whisper mode”, that is, not by directly responding to the caller, but by listening to the message left by the caller in real time while it is being recorded, offering the option to interrupt the process and establish a conversation with the caller.

The handsfree device disclosed in WO 2006/136266 thus acts to provide a local voicemail service by recording a voicemail message in local memory in the handsfree device. When the handsfree device detects an incoming call as received and forwarded from the mobile terminal, the handsfree device reads a greeting message from its local memory and generates an audio signal to be played to the caller. The caller will thus be informed that he has reached a mailbox service and that he may leave a spoken voicemail message to the intended call recipient. According to WO 2006/136266, the greeting message may also typically inform the caller about the existence of the “whisper mode”, i.e. that the receiver may listen to the voicemail message as it is being recorded, and may decide to pick up the call if desired.

It is to be noticed that in WO 2006/136266, the greeting message is a single predefined message, i.e. its content has been defined at some previous point in time, and the handsfree device has no means which allows later modification of the greeting message.

### SUMMARY

An object of the invention is to provide a portable handsfree device with improved local voicemail service compared to the prior art as referred to above.

As a conceptual understanding behind the invention, it has been realized that a single predefined greeting message does not draw full benefit of the potential usability of a portable handsfree device with local, or “built-in”, voicemail service.

Based on this conceptual understanding, the idea has been reduced to practice at least according to the aspects and embodiments of the invention referred to below.

One aspect of the present invention therefore is a portable handsfree device for use with a mobile terminal, the portable handsfree device comprising:
an audio interface over which a user may conduct voice calls;
a processing unit; and
a memory unit,
wherein the processing unit is adapted for providing a local voicemail service by playing a greeting message to a caller of an incoming voice call to said mobile terminal and recording, in said memory unit, a voicemail message from said caller, and
wherein the processing unit is adapted for making the greeting message configurable by said user.

Making the greeting message configurable by the user will increase the usability of the portable handsfree device.

In one embodiment, the memory unit has memory areas for storing a plurality of greeting message alternatives, and the processing unit is adapted for selecting the greeting message to be played to the caller from among the stored plurality of greeting message alternatives.

Having a plurality of prestored greeting message alternatives allows for real-time selection of an appropriate greeting message to be played to the caller of an incoming call, more tailored to the particular caller than a single predefined greeting message.

In one advantageous embodiment, the portable handsfree device further comprises a user interface over which the user may control the portable handsfree device, and the processing unit is adapted to
receive caller identifying information for the incoming voice call from the mobile terminal;
cause presentation of the caller identifying information in the user interface;
accept from the user interface an action made by the user indicating one of said plurality of greeting message alternatives; and
cause said one greeting message alternative to be played as said greeting message.

This will allow the user to manually select which greeting message alternative to use based on the caller identifying information shown on the local display of the portable handsfree device.

Additionally or alternatively, the portable handsfree device may automatically select which greeting message alternative to use by analyzing the received caller identifying information. In such an embodiment, the processing unit of the portable handsfree device is adapted to:
receive caller identifying information for the incoming voice call from the mobile terminal;
analyze the received caller identifying information to determine at least one of a type or an identity of the caller; and
select the greeting message to be played to the caller from among the stored plurality of greeting message alternatives based on the determined type or identity of the caller.

Advantageously, the memory unit of the portable handsfree device has memory areas for storing defined rules, which are configurable by said user and which associate possible types or identities of callers with different ones of the stored plurality of greeting message alternatives, wherein the processing unit is adapted to apply the defined rules for selecting the greeting message to be played to the caller from among the stored plurality of greeting message alternatives.

This will allow the user to configure the rules on how the portable handsfree device shall select which greeting message alternative to use for an incoming call.

Advantageously, geographical origin, or likely language preference, of a caller is a factor when the portable handsfree device automatically selects which greeting message alternative to use. This may be obtained by an embodiment for which the portable handsfree device receives caller identifying information which includes a telephone number of the caller,
wherein the processing unit is adapted to estimate a language preference of the caller by analyzing at least one of a country code or an area code of the telephone number of the caller, and
wherein the stored plurality of greeting message alternatives includes at least two messages in different languages.

Additionally or alternatively, the geographical origin, or likely language preference, of the caller may be assessed in an embodiment for which the portable handsfree device receives caller identifying information which includes information from a contacts book entry associated with the caller,
wherein the processing unit is adapted to estimate a language preference of the caller by analyzing at least one of a country field, an area field, a zip code field or an address field of the contacts book entry, and
wherein the stored plurality of greeting message alternatives includes at least two messages in different languages.

In one advantageous embodiment, the processing unit of the portable handsfree device is adapted to
receive caller identifying information for the incoming voice call from the mobile terminal, said caller identifying information including a telephone number of the caller;
store in said memory unit at least the telephone number of the caller together with the voicemail message recorded by the caller;
accept a voicemail message playback command from the user over the user interface;
cause playback over the audio interface of the voicemail message stored in the memory unit;
accept a recall command from the user over the user interface; and
cause generation of a voice call back to the caller via said mobile terminal.

This will provide the user with a recall feature, i.e. offering him to place a call back to a caller after having listened to a voicemail message left by the latter.

In addition to the alternatives given above, the greeting message of the portable handsfree device may also be made configurable by adapting the processing unit of the portable handsfree device to
accept over the audio interface a new greeting message as spoken by the user;
store a digital audio representation of the new greeting message in the memory unit; and
use the stored digital audio representation in the memory unit for playing the greeting message to the caller of the incoming voice call.

It should be emphasized that the term “comprises/comprising” when used in this specification is taken to specify the presence of stated features, integers, steps, or components, but does not preclude the presence or addition of one or more other features, integers, steps, components, or groups thereof.

### BRIEF DESCRIPTION OF THE DRAWINGS

Objects, features and advantages of embodiments of the invention will appear from the following detailed description, reference being made to the accompanying drawings, in which:

FIG. 1 is a schematic illustration of a non-limiting example of an environment in which embodiments of the present invention may be exercised;

FIG. 2 is a schematic front view of a portable handsfree device according to an embodiment of the present invention, used together with a mobile terminal; and

FIG. 3 is a schematic block diagram representing the major components, within the context of the present invention, of a portable handsfree device according to one embodiment.

### DETAILED DESCRIPTION

Embodiments of the invention will be now described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

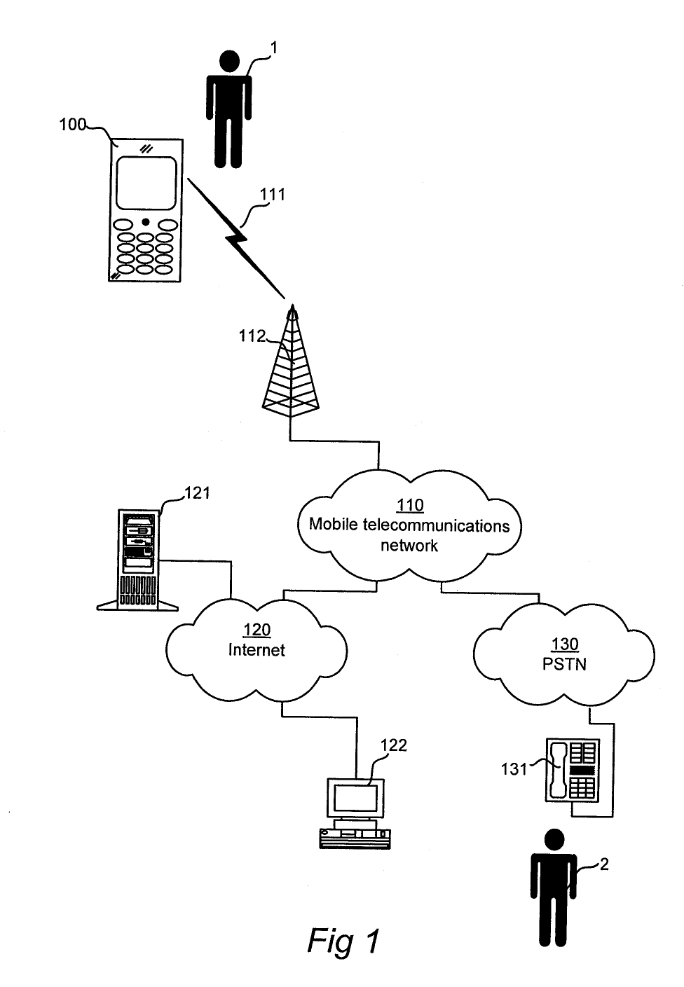

Before turning to a detailed description of the disclosed embodiments, an exemplifying environment in which they may be exercised will now be briefly described with reference to FIG. 1.

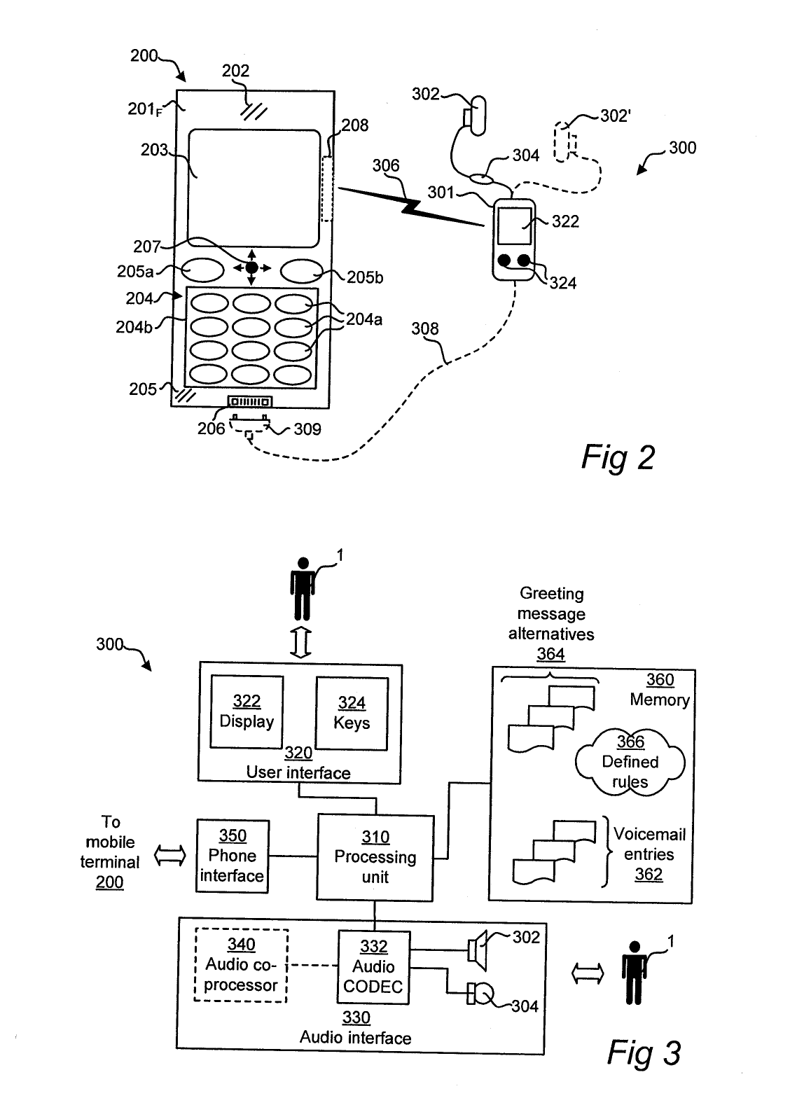

In FIG. 1, a portable electronic apparatus in the form of a mobile terminal 100 is part of a cellular telecommunications system. A user 1 of the mobile terminal 100 may conduct voice calls with other users accessible through the cellular telecommunications system. As will be explained in more detail in the following, the user 1 may use a portable handsfree device 300 (FIG. 2, FIG. 3) as an accessory for such voice calls. In the remainder of this section, the user 1 will be described as the receiver, recipient or callee of an incoming voice call from another user or caller 2. The caller 2 may use any available equipment in or connected to the cellular telecommunications system in order to call the user 1. In addition to voice calls, the user 1 may use various other tele-communications services, such as Internet browsing, video calls, data calls, facsimile transmissions, still image transmissions, video transmissions, electronic messaging, and e-commerce. Such additional telecommunication services are however not central within the context of the present invention; there are no limitations to any particular set of services in this respect.

The mobile terminal 100 connects to a mobile telecommunications network 110 over a radio link 111 and a base station 112. The mobile terminal 100 and the mobile telecommunications network 110 may comply with any commercially available mobile telecommunications standard, including but not limited to GSM, UMTS, D-AMPS, CDMA2000, FOMA and TD-SCDMA.

A conventional public switched telephone network (PSTN) 130 is connected to the mobile telecommunications network 110. Various telephone terminals, including a stationary telephone 131, may connect to the PSTN 130.

The mobile telecommunications network 110 is also operatively associated with a wide area data network 120, such as the Internet. Server computers 121 and client computers 122 may be connected to the wide area data network 120 and therefore allow communication with the mobile terminal 100.

An embodiment 300 of the portable handsfree device is illustrated in more detail in FIG. 2 together with a possible implementation 200 of the mobile terminal 100. Starting with the latter, the mobile terminal 200 has a housing that includes a front side 201_{F}. The front side 201_{F} has a man-to-machine interface (MMI), or user interface, which includes a speaker or earphone 202, a microphone 205, a display 203, and an ITU-T-type keypad 204 having twelve alpha-numeric keys distributed within a keypad area 204b, wherein the keys represent the digits 0-9 and the characters * and #. Certain other special keys such as soft keys 205a, 205b may also be provided. Furthermore, the mobile terminal 200 may also have a navigational input device 207, such as a joystick, a touch pad, a rotator, a jog dial or a set of arrow keys (navigation keys). Other well-known external components may also be provided, such as power switch, battery, volume controls and external antenna, but are not indicated in FIG. 2 for the sake of brevity.

The mobile terminal 200 also has one or more machine-to-machine interface(s). In FIG. 2, there is shown a first interface 206 which can be used in a well known manner for connecting an accessory such as a charger. The first interface 206 may be a serial interface such as, for instance, Universal Serial Bus (USB). Furthermore, the mobile terminal 200 has a second interface 208 which is wireless and can be used for wireless connection of accessories and for short-range wireless data communication. The second interface 208 may for instance be compliant with the Bluetooth™ standard, or IrDA (Infrared Data Association), WLAN (Wireless Local Area Network) or NFC (Near Field Communication).

As seen in FIG. 2, and within the context of the invention, the user 1 (FIG. 1) may typically connect his portable handsfree device 300 to his mobile terminal 200 via a wireless link 306 and the second wireless interface 208. Alternatively, the user 1 may connect his portable handsfree device 300 to his mobile terminal 200 via a cable-based connection 308 and a connector 309 to the accessory interface 206. In the embodiment shown in FIG. 2, the portable handsfree device 300 has one or more speaker(s) 302, 302′, one or more microphone(s) 304, a display 322 and a set of keys 324.

The internal component structure of the portable handsfree device 300 according to one embodiment will now be described with reference to FIG. 3. The portable handsfree device 300 of FIG. 3 has a processing unit 310 which serves as a controller of other components. For instance, the processing unit 310 is operatively coupled with a user interface 320 of the portable handsfree device. In the disclosed embodiment, the user interface 320 comprises the keys 324 and the display 322, and it enables the user 1 to control the portable handsfree device 300, its different operation modes and its interaction with the mobile terminal 200. In other embodiments, the user interface 320 may comprise other elements than keys and a display, including but not limited to voice control functionality.

The processing unit 310 may be implemented by any commercially available and suitably programmed CPU (“Central Processing Unit”) or DSP (“Digital Signal Processor”), or alternatively by any other electronic logic device such as an FPGA (“Field-Programmable Gate Array”), an ASIC (“Application-Specific Integrated Circuit”) or basically any combination of digital and/or analog components which, in the mind of a skilled person, would be a natural choice in order to implement the disclosed functionality.

The processing unit 310 also includes, is coupled to or otherwise associated with a memory unit 360. The memory unit 360 may be realized by any available kind of memory device, such as a RAM memory, a ROM memory, an EEPROM memory, a flash memory, a hard disk, or any combination thereof, and may be made up of a single physical memory device or a plurality of physical memory devices. The memory unit 360 may be used for various purposes by the processing unit 310, including storing of data and program instructions required for the functionality to be provided by the portable handsfree device 300.

The portable handsfree device 300 has a phone interface 350 for connection to the mobile terminal 200. Thus, the phone interface 350 may be an interface for short-range wireless data communication (cf link 306 in FIG. 2) such as Bluetooth™, IrDA, WLAN or NFC, and/or it may be an interface for cable-based communication such as USB (cf cable connection 308 in FIG. 2). The phone interface 350 enables transmission and reception of control signals as well as audio signals between the portable handsfree device 300 and the mobile terminal 200.

The portable handsfree device 300 moreover has an audio interface 330 which includes the speaker 302 and microphone 304. In a manner well known per se, the microphone 304 will convert acoustic signals, emanating from the voice of the user 1, into electrical audio signals. Correspondingly, the speaker 302 will convert electrical audio signals into acoustic signals, which the user 1 can listen to. An audio CODEC 332 is arranged to transform the electric audio signals from the microphone into a format suitable for the processing unit 310. The Audio CODEC 332 is also used to transform audio data from the processing unit 310 into electrical audio signals to the loudspeaker 302.

As is seen by a dashed box 340 in FIG. 3, the audio interface 330 may in some embodiments comprise an audio co-processor, speech synthesizer or other circuitry which will assist the audio CODEC 332 and the processing unit 310 in their tasks of handling, processing and transforming voice-related data and signals. In some embodiments, at least some of the components of the portable handsfree device 300 may be integrated into the same electronic circuit chip.

The portable handsfree device 300 also comprises a power supply unit (not shown) which supplies power to the different components of the device 300. For embodiments which connect over a wireless link 306 to the mobile terminal 200, the power supply unit will typically include one or more batteries and circuitry for battery charging. For embodiments which connect over a cable connection 308 to the mobile terminal 200, the power supply unit may include an interface (e.g. a USB interface) for receiving and using electric energy from the mobile terminal 200 for driving the components of the portable handsfree device 300.

The operation of the portable handsfree device 300 will now be described in further detail. Initially, it is assumed that the user 1 has connected the portable handsfree device 300 to his mobile terminal 200 in any of the ways previously explained. The caller 2 makes a telephone call to the user 1, and the mobile telecommunications network 110 of FIG. 1 routes the incoming call to the mobile terminal 200 (100) of the user 1. The processing unit 310 in the portable handsfree device 300 is notified of the incoming call by the mobile terminal 200 through the phone interface 350, and further alert may be given to the user 1 through the user interface 320 and/or speaker 302.

The user 1 may answer the call in the traditional way by making a call accept command in the user interface 320, wherein the processing unit 310 accordingly will communicate with the mobile terminal 200 to have the call established and then act to control the audio interface 330 to produce sound through the speaker 302—corresponding to the voice of the caller 2—and to receive sound through the microphone 304 as generated by the voice of the user 1.

Alternatively, however, the portable handsfree device 300 may use its local voicemail service and present the caller 2 to the functionality of an answering machine. Whether or not the local voicemail service shall be invoked for an incoming call can be determined in different ways. For instance, a first way is to provide the local voicemail service as an operational mode which can be enabled or disabled by the user 1 of the portable handsfree device 300 through the user interface 320. When this operational mode is enabled, any incoming call would be subjected to local voicemail service, whereas when disabled, incoming calls would trigger a ringtone and be answerable as usual. A second way is to allow the user 1 some time to answer the incoming call before local voicemail service is invoked. The delay for this may be set by the user 1, e.g. in the form of x ringtones or y seconds. A third way is to generated ringtones for incoming calls but allow the user 1 to send the incoming call to local voicemail service by performing a command in the user interface 320. Combinations of these ways are also possible, and so are other ways not explicitly disclosed herein but easily conceivable by a man skilled in the art.

When the processing unit 310 in the portable handsfree device 300 invokes local voicemail service, it causes playing of a greeting message to the caller 2 to inform him that he has reached a mailbox service and that he may leave a spoken voicemail message to the intended call recipient. Within the concept of the present invention, this greeting message is made configurable by the user 1, as will be explained in more detail later. In embodiments of the invention, the greeting message may also serve to notify the caller about the existence of a “whisper mode” like in the aforementioned WO 2006/136266—i.e. that the receiver of the call may listen to the voicemail message as it is being recorded, and may decide to pick up the call if desired.

When the greeting message has finished playing, the caller 2 may start leaving his voicemail message (e.g. to explain the reason of his call), which will be recorded by the processing unit 310 as a voicemail entry 362 in the memory unit 360 of the portable handsfree device 300. In embodiments that offer “whisper mode”, the processing unit 310 will cause playback of the voicemail message, as it is still being recorded, to the user 1 through the audio interface 330, so that the user 1 may decide whether to answer the call or not. If so, the user 1 and caller 2 may start talking in a normal telephone call conversation once the processing unit 310 has activated the microphone 304, if required.

At any time, the user 1 can listen to a stored voicemail entry 362 by making a request in the user interface 320. If several voicemail entries 362 are stored in the memory unit 360, they may typically be listened to, skipped or deleted in a sequential order.

When the user 1 requests playback of a stored voicemail entry 362, the processing unit 310 will read the voicemail entry 362 from the memory unit 360 and control the audio interface 330 to reproduce the corresponding acoustic signal through the loudspeaker 304. After playback of the stored voicemail entry 362, it may be kept in or deleted from the memory unit 360 depending on a default setting of a user preference set in the memory unit 360, or a user command given through the user interface 320.

In accordance with embodiments of the invention, some different and beneficial ways of making the greeting message of the local voicemail service configurable by the user 1 will now be described.

In one embodiment, the portable handsfree device 300 is adapted to store several greeting message alternatives 364 in memory areas of the memory unit 360. When local voicemail service is invoked, the processing unit 310 will select the greeting message to be played to the caller 2 from among the stored plurality of greeting message alternatives 364.

In one refinement of this embodiment, the user 1 may manually select one of the stored greeting message alternatives 364 for use as the greeting message to be played to the caller 2. To assist the user 1 in this selection, the processing unit 310 is adapted to receive caller identifying information for the incoming voice call from the mobile terminal 200. In this or other embodiments, such caller identifying information may be the telephone number (A number) of the caller 2. To this end, the caller identifying information may be communicated over the mobile telecommunications network 110 using existing network functionality known as, for instance, Caller ID, Caller Identification (CID), Calling Number Identification (CNID), or Calling Line Identification Presentation (CLIP). Some networks similarly allow for communication of the name of the caller 2, instead of or in addition to his telephone number.

If the caller identifying information received from the mobile telecommunications network 110 for the incoming call does contain a telephone number but not an associated name, the mobile terminal 200 may be configured to search for the detected telephone number of the caller 2 in a Contacts application stored in local or remote memory, and to retrieve the corresponding name of the user 2 from a matching entry in the Contacts application. Such retrieved name information may then be included in the caller identifying information sent from the mobile terminal 200 to the portable handsfree device 300.

Upon receipt of the caller identifying information in the portable handsfree device 300, the processing unit 310 will cause presentation of the caller identifying information, or a part thereof, in the user interface 320. The presented caller identifying information will assist the user 1 in determining who the caller 2 is, and, in particular, which of the plurality of greeting message alternatives 364 that is best used for this particular caller 2.

The selection may be done in different ways. According to one alternative, the available greeting message alternatives 364 are represented on the display 322, and the user 1 may use the keys 324 to select the desired alternative. Because of the typical small size of the portable handsfree device 300 and therefore its display 322, the available greeting message alternatives 364 may be represented as icons, labels or abbreviations on the display 322.

According to another alternative, the available greeting message alternatives 364 in the memory unit 360 are mapped to different ones of the keys 324 in the user interface 320, for instance such that a first of the keys 324 represents a greeting message alternative which is to be used for family members, whereas a second of the keys 324 represents a greeting message alternative intended for friends, and a third key 324 represents a standard, “official” greeting message intended for all other callers, including unknown ones.

Once a greeting message alternative has been selected by the user 1 via the user interface 320, the processing unit 310 will cause the selected greeting message alternative to be played as the greeting message to the caller 2.

In another refinement of the embodiment referred to above with several greeting message alternatives 364, the portable handsfree device 300 automatically selects which greeting message alternative to use. This automatic selection is based on received caller identifying information for the incoming voice call from the mobile terminal 200. The processing unit 310 analyzes the received caller identifying information to determine at least one of a type or an identity of the caller 2, and then selects the greeting message to be played to the caller from among the stored plurality of greeting message alternatives 364 in the memory unit 360 based on the determined type or identity of the caller 2. To this end, the memory unit 360 has memory areas for storing defined rules 366, which associate possible types or identities of callers with different ones of the stored plurality of greeting message alternatives 364, and the processing unit 310 is adapted to apply these defined rules 366 for selecting the greeting message to be played to the caller 2 from among the stored plurality of greeting message alternatives.

For example, the defined rules 366 may categorize different potential callers into different groups, each having its own greeting message alternative 364. One or more such group(s) may include known telephone numbers (or other kind of caller identifying information) of family members, relatives, friends, etc, whereas one or more other group(s) may include known telephone numbers of professional contacts within for instance business, education or public authorities.

In one advantageous improvement, the defined rules 366 are configurable by the user 1. It is conceived that this may be done through the local user interface 320, or alternatively—if a more convenient user interface is desired—by means of a settings application run in the mobile terminal 200 or at a remote computer connected to the mobile terminal 200. In the latter case, any changes made by the user 1 to the defined rules 366 will be received by the processing unit 310 over the phone interface 350 and stored in the memory unit 360.

In one advantageous improvement, the geographical origin, or likely language preference, of the caller 2 is a factor when the portable handsfree device 300 automatically selects which greeting message alternative to use. To accomplish this, the processing unit 310 may detect a telephone number of the caller 2 as included in the caller identifying information, and then the processing unit 310 may be adapted to estimate a language preference of the caller 2 by analyzing at least one of a country code or an area code in the detected telephone number. The stored plurality of greeting message alternatives 364 may include at least two messages in different languages, and the defined rules 366 may specify which greeting message alternative to use for different country codes or area codes.

Alternatively, the geographical origin, or likely language preference, of the caller 2 may be determined from a Contacts entry available to the mobile terminal 200. By receiving, in the caller identifying information from the mobile terminal 200, information from a contacts book entry associated with the caller 2, the processing unit 310 may be adapted to estimate a language preference of the caller 2 by analyzing at least one of a country field, an area field, a zip code field or an address field of the received information from the contacts book entry. Again, the stored plurality of greeting message alternatives 364 may include at least two messages in different languages, and the defined rules 366 may specify which greeting message alternative to use for different geographical data derivable from contacts book entries.

In one embodiment, the portable handsfree device 300 is adapted to provide the user 1 with a recall feature according to the following. When caller identifying information for the incoming voice call has been received from the mobile terminal 200), the processing unit 310 will act to store in the memory unit 360 at least the telephone number of the caller 2 together with the voicemail message 362 recorded by the latter. Subsequently, when having accepted a voicemail message playback command from the user 1 over the user interface 320, the processing unit 310 will cause playback over the audio interface 330 of the voicemail message 362, as already described earlier in this document. In addition, the processing unit 310 is adapted to accept a recall command from the user 1 over the user interface 320, and in response to this cause generation of a voice call back to the caller 2 via the mobile terminal 200.

In one embodiment, the greeting message of the local voicemail service is made configurable by the user 1 in the following way. The processing unit 310 is adapted for accepting over the audio interface 330 a new greeting message as spoken by the user 1. Using the audio CODEC 332, the processing unit 310 will store a digital audio representation of the new greeting message in the memory unit 360. For embodiments which handle a plurality of greeting message alternatives 364, the digital audio representation may be stored as one of these greeting message alternatives 364—either replacing an existing one, or being added as a new alternative. For embodiments where the defined rules 366, which associate possible types or identities of callers with different ones of the stored plurality of greeting message alternatives 364, are configurable by the user 1, the user 1 may act to update the defined rules 366 if required. Subsequently, the stored digital audio representation in the memory unit 360 will be read by the processing unit 310 for playing the greeting message to the caller 2 of the incoming voice call.

The invention has been described above with reference to some embodiments thereof. However, as is readily understood by a skilled person, other embodiments are also possible within the scope of the present invention, as defined by the appended claims.

What is claimed is:

1. A portable handsfree device for use with a mobile terminal, the portable handsfree device comprising:
an audio interface over which a user may conduct voice calls;
a processing unit; and
a memory unit,
wherein the processing unit is adapted for providing a local voicemail service by playing a greeting message to a caller of an incoming voice call to said mobile terminal and recording, in said memory unit, a voicemail message from said caller, and
wherein the processing unit is adapted for making the greeting message configurable by said user.

2. The portable handsfree device as defined in claim 1,
wherein the memory unit has memory areas for storing a plurality of greeting message alternatives, and
wherein the processing unit is adapted for selecting the greeting message to be played to the caller from among the stored plurality of greeting message alternatives.

3. The portable handsfree device as defined in claim 2, the device further comprising a user interface over which the user may control the portable handsfree device,
wherein the processing unit is adapted to
receive caller identifying information for the incoming voice call from the mobile terminal;
cause presentation of the caller identifying information in the user interface;
accept from the user interface an action made by the user indicating one of said plurality of greeting message alternatives; and
cause said one greeting message alternative to be played as said greeting message.

4. The portable handsfree device as defined in claim 3, wherein the caller identifying information is one or more from the group consisting of:
a telephone number of the caller,
a name associated with the caller, and
information from a contacts book entry associated with the caller.

5. The portable handsfree device as defined in claim 2, wherein the processing unit is adapted to:
receive caller identifying information for the incoming voice call from the mobile terminal;
analyze the received caller identifying information to determine at least one of a type or an identity of the caller; and
select the greeting message to be played to the caller from among the stored plurality of greeting message alternatives based on the determined type or identity of the caller.

6. The portable handsfree device as defined in claim 5, the memory unit having memory areas for storing defined rules, which are configurable by said user and which associate possible types or identities of callers with different ones of the stored plurality of greeting message alternatives,
wherein the processing unit is adapted to apply the defined rules for selecting the greeting message to be played to the caller from among the stored plurality of greeting message alternatives.

7. The portable handsfree device as defined in claim 5, the caller identifying information including a telephone number of the caller,
wherein the processing unit is adapted to estimate a language preference of the caller by analyzing at least one of a country code or an area code of the telephone number of the caller, and
wherein the stored plurality of greeting message alternatives includes at least two messages in different languages.

8. The portable handsfree device as defined in claim 5, the caller identifying information including information from a contacts book entry associated with the caller,
wherein the processing unit is adapted to estimate a language preference of the caller by analyzing at least one of a country field, an area field, a zip code field or an address field of the contacts book entry, and
wherein the stored plurality of greeting message alternatives includes at least two messages in different languages.

9. The portable handsfree device as defined in claim 1, the device further comprising a user interface over which the user may control the portable handsfree device,
wherein the processing unit is adapted to
receive caller identifying information for the incoming voice call from the mobile terminal, said caller identifying information including a telephone number of the caller;
store in said memory unit at least the telephone number of the caller together with the voicemail message recorded by the caller;
accept a voicemail message playback command from the user over the user interface;
cause playback over the audio interface of the voicemail message stored in the memory unit;
accept a recall command from the user over the user interface; and
cause generation of a voice call back to the caller via said mobile terminal.

10. The portable handsfree device as defined in claim 1,
wherein the processing unit is adapted for making the greeting message configurable by said user by
accepting over the audio interface a new greeting message as spoken by the user;
storing a digital audio representation of the new greeting message in the memory unit; and
using the stored digital audio representation in the memory unit for playing the greeting message to the caller of the incoming voice call.
